(19) United States
(12) Patent Application Publication
(10) Pub. No.: US 2009/0205272 A1
(43) Pub. Date: Aug. 20, 2009

(54) Window Buck

(76) Inventor: John Rosende, Tampa, FL (US)

Correspondence Address: Maxey Law Offices, PLLC, 13630 58TH ST. NORTH, SUITE 101, CLEARWATER, FL, 33760, US

(21) Appl. No.: 12/031,812

(22) Filed: Feb. 15, 2008

(51) Int. Cl. E06B 1/36

(52) U.S. Cl. 52/215

(57) ABSTRACT

A window buck having frame members forming a frame having an opening for receiving a window. The frame members are constructed to enable use of the window buck in the construction of poured walls, block walls and framed walls. The frame members are milled from stock material according to specific specifications and are delivered assembled to the construction site ready to be placed in a wall under construction. A removable structural web is inserted into the opening and attached to the frame to provide structural support during transport and during wall construction. The particular construction of the frame members provides the window buck with an integral sill pan and improves waterproofing of the window construction.

### FILED OF THE INVENTION

The present invention relates generally to window bucks used for forming a window opening in a wall, and more particularly, relating to a performed window buck that may be used for creating a window opening in several different wall constructions including concrete poured walls, concrete block walls and framed walls.

### BACKGROUND OF THE INVENTION

Window bucks are commonly used in the construction of walls of concrete and serve to block out an area in the wall during pouring of concrete. Typically, the window buck is supported in place by the wall form and is left in place once the concrete has hardened to receive a window. In the construction of poured concrete walls, insulative sheet material applied to reinforcing steel may serve as the wall form, and may become an integral part of the wall to increase wall insulating properties and to simplify construction.

U.S. Pat. No. 5,996,293 discloses a window buck for blocking out a wall area for later reception of a window. The window buck is constructed of elongated channel members of extruded PVC that are joined at their ends by locking members. The channel members are cut to size and joined together at the site of construction by the locking members which connect the ends of two adjacent channel members. Flanges extending from outward facing surfaces of the channel members are set within the concrete wall during pouring to provide a permanent connection to the concrete wall.

U.S. Pat. No. 6,453,620 discloses a window buck having members forming a frame with the members including adjustable components enabling use of the buck in walls under construction of different thickness. The frame members are connected at their ends by connectors which are removable once the concrete wall has hardened. The members include projecting flanges that are set within the concrete during pouring to provide a permanent connection to the concrete wall.

U.S. Pat. No. 5,791,103 a window buck made of extruded irregular shapes consisting of a combination of cellulose and polymer compounded specifically to be used in connection with building walls of poured concrete. The combination desirably is a mixture of approximately 70% cellulose and approximately 30% polymer. The cellulose is preferably sawdust, and the polymer preferably is polyethylene. Flanges extend from outward facing surfaces of the channel members are set within the concrete wall during pouring to provide a permanent connection to the concrete wall.

While the window bucks heretofore fulfill their respect, particular objectives and requirements, they do have certain drawbacks, including, they cannot be used in the construction of block walls or framed walls. Additionally, they need to be fit and assembled on site, and require the use of connector elements to join the edges of the frame members, which is time consuming and can result in a window buck that is not perfectly square causing sealing issues with the subsequently installed window. Further, they are not readily customizable to non-standard window dimensions, desired window setback and window inset, and non-conventional wall thickness.

Accordingly, there is a need for a window buck that can be used in poured wall constructions, block wall constructions and framed wall constructions. Further, there is a need for a window buck that can be readily manufactured and assembled to a particular specification and delivered to a job site ready for installation with little or no alteration required at the job site. Further yet, there is a need for a window buck which improves the sealing interface between the window buck and the wall and improves the sealing interface between the window buck and a window installed in the window buck.

### SUMMARY OF THE INVENTION

The preferred embodiments of the present invention addresses this need by providing a window buck construction that can be used not only in poured wall constructions but also in block wall constructions and framed wall constructions. The preferred embodiments further provide a window buck construction that is readily manufactured and assembled for delivery to the job site ready to be positioned within a wall under construction. Additionally, the preferred embodiments of the present invention provide a window buck that improves the sealing interface between the window buck and the wall and provides an improved sealing interface between the installed window and the window buck. Further yet, the preferred embodiments of the present invention provide a window buck having an integral sill pan.

To achieve these and other advantages, in general, in one aspect, a window buck for forming a window opening in a wall is provided. The window buck includes a plurality of elongated frame members each having a inward facing edge, an outward facing edge, opposed ends, an outward facing surface extending between the opposed ends and the inward and outward facing edges, a first inward facing surface extending along the outward facing edge, a second inward facing surface extending along the inward facing edge and at a laterally spaced distance from the first inward facing surface, an interface edge joining the first and the second inward facing surfaces, and a width that is at least equal to the thickness of the wall into which the window buck is to be placed. The plurality of elongated frame members joined at their opposed ends to form a frame defining an opening with the first inward facing surfaces facing each other defining a first interior perimeter, and with the second inward facing surfaces facing each other defining a second interior perimeter, the first perimeter being greater than the second interior perimeter. And the outward facing surface of each of the plurality of elongated frame members is substantially planar and is free from outwardly extending flanges.

In general, in another aspect, a window system for a wall is provided. The window system includes a window buck having a plurality of elongated frame members each having a inward facing edge, an outward facing edge, opposed ends, an outward facing surface extending between the opposed ends and the inward and outward facing edges, a first inward facing surface extending along the outward facing edge, a second inward facing surface extending along the inward facing edge and at a laterally spaced distance from the first inward facing surface, an interface edge joining the first and the second inward facing surfaces, and a width that is at least equal to the thickness of the wall into which the window buck is to be placed. The plurality of elongated frame members joined at their opposed ends to form a frame defining an opening with the first inward facing surfaces facing each other defining a first interior perimeter, and with the second inward facing surfaces facing each other defining a second interior perimeter, the first perimeter being greater than the second interior perimeter. And the outward facing surface of each of the plurality of elongated frame members is substantially planar and is free from outwardly extending flanges. A window assembly including a window frame. The window buck positioned within a wall with the outward facing edge at least being flush with an outward facing surface of the wall. The window assembly is positioned within the second perimeter with the window frame secured at least to one of the second inward facing surfaces of the plurality of elongated frame members. A seal at the interface of the window frame and the inward facing surfaces of the plurality of elongated frame members.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The accompanying drawings, which are included to provide further understanding of the invention and are incorporated in and constitute a part of this specification, illustrate preferred embodiments of the invention and together with the description serve to explain the principles of the invention, in which:

FIG. 1 is a perspective view of the window buck constructed in accordance with the principles of the present invention;

FIG. 2 is a partial lateral cross sectional view the window buck positioned within a poured concrete wall taken through a bottom frame member used to construct the window buck;

FIG. 3 is a front elevation view of the window buck;

FIG. 4 is a partial lateral cross sectional view the window buck positioned within a block constructed wall taken through a bottom frame member used to construct the window buck;

FIG. 5 is a partial lateral cross sectional view the window buck positioned within a frame constructed wall taken through a bottom frame member used to construct the window buck;

FIG. 6 is a partial lateral cross sectional view of an alternate configuration of the window buck taken through a bottom frame member used to construct the window buck;

FIG. 7 is a partial lateral cross sectional view of an alternate configuration of the window buck taken through a bottom frame member used to construct the window buck;

FIG. 8 is a perspective view of frame members suitable for use in forming the window buck frame; and

FIG. 9 is a perspective view of the window buck including a removable structural web for providing support to the frame members during transport of the window buck and during wall construction.

### DETAILED DESCRIPTION OF THE INVENTION

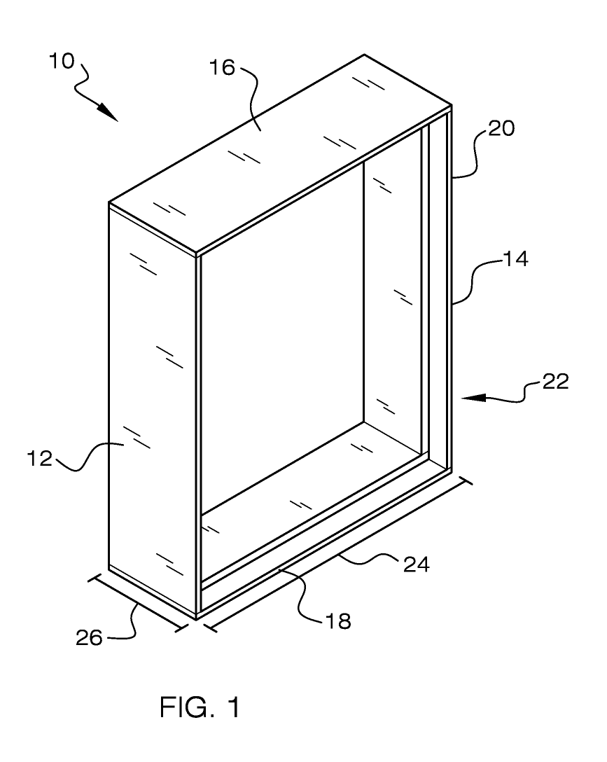

Reference will now be made in detail to the preferred embodiments of the present invention, examples of which are illustrated in the accompanying drawings. Referring now to FIGS. 1-9 of the drawings, reference numeral 10 generally designates window buck of the present invention.

FIG. 1, illustrates a front perspective of one embodiment of the window buck 10. The window buck 10 includes a plurality of elongated frame members, including a left side member 12, a right side member 14, a top side member 16 and a bottom side member 18. The frame members 12, 14, 16, and 18 are joined at their ends to form a frame 20 defining an opening 22 for receiving a window (not shown) after construction of a wall, as more fully discussed hereinafter. The frame members 12, 14, 16, and 18 are dimensioned such that the frame 20 is formed to have an outer length 24 and an outer width 26. The outer width 26 is selected to be at least the width of the wall into which the window buck 10 is to be placed.

The frame members 12, 14, 16, and 18 may each be formed from a synthetic material, a composite material, a material at least comprising a cellular material or combinations thereof. Preferably, the frame member 12, 14, 16 and 18 are formed from a foamed polyvinyl chloride (PVC) material. The frame members 12, 14, 16 and 18 may be formed by extrusion, casting, molding, milling from stock material or combinations thereof to dimensions required to meet the desired specifications. Other suitable materials that may be used to form the frame members 12, 14, 16 and 18 include metal alloys, vinyl, vinyl-like material, vinyl-type material, plastics or combinations thereof.

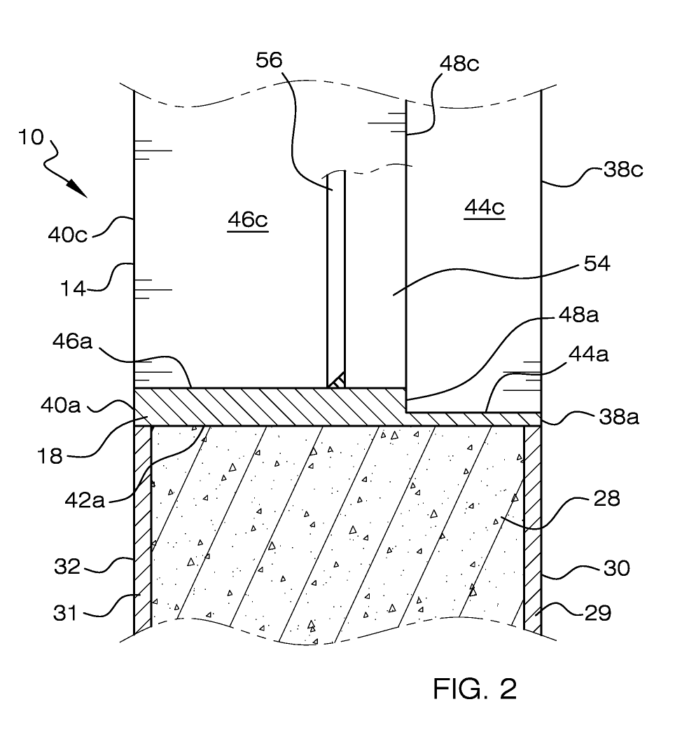

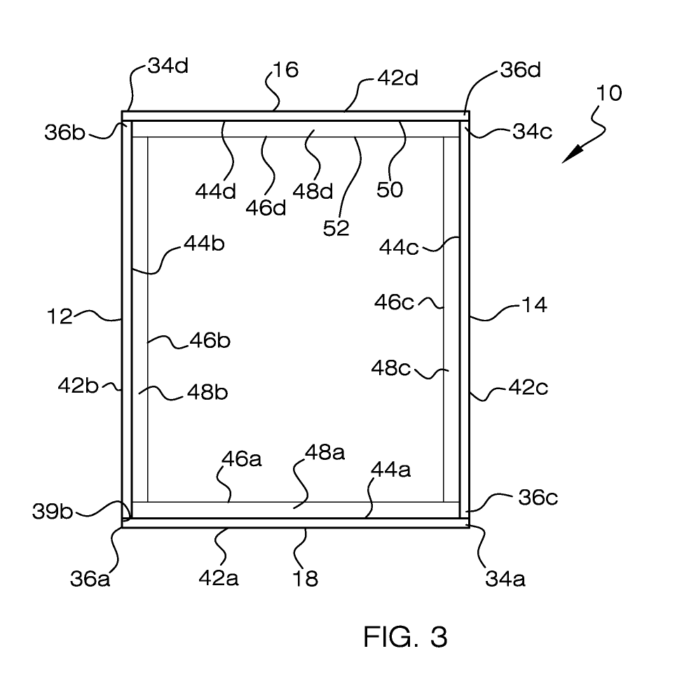

In FIG. 2, there is shown a lateral cross section of one of the frame members 18 taken approximately at a longitudinal mid-point positioned within a wall 28 constructed of poured concrete. The wall 28 includes a surface 30 that is outwardly facing and a surface 32 that interiorly facing. This particular wall 28 is constructed using insulative frame members 29 and 31 that remain in place and become integral with the wall. The lateral cross section of each of the frame member 12, 14, 16 and 18 are the same, as such the following description of frame member 18 applies to the remaining frame members. Like reference numbers refer to like elements between the frame members 12-18. Frame member 18 includes opposed ends 34a and 36a (FIG. 3), a first edge 38a that is outwardly facing and a second edge 40a that is inwardly facing. An outwardly facing surface 42a is bounded by the opposed ends 34a and 36a, and edges 38a and 40a. The outwardly facing surface 42a is planar and does not include any flanges or other extending members that extend in a direction outwardly therefrom. On the side opposite the outwardly facing surface 42a there is a first inwardly facing surface 44a, and a second inwardly facing surface 46a. The second inwardly facing surface is laterally spaced from the first inwardly facing surface 44a creating a ledge having an interface edge 48a joining the first and second inwardly facing surfaces. The first inward facing surface 44a extends along edge 38a from approximate ends 34a and 36a. The second inward facing surface 46a extends along edge 40a from approximate ends 34a and 36a. As can be seen, frame member 18 has a width that is at least equal to the thickness of the wall 28.

With further reference to FIG. 3, the frame members are joined at their ends 34a-34d and 36a-36d to form the frame 20 with the first inwardly facing surfaces 44a-44d each facing each other and with the second inwardly facing surfaces 46a-46d each facing each other. Together, the first inwardly facing surfaces 44a-44d defining a first interior perimeter 50 bounded by the first inwardly facing surfaces. Together, the second inwardly facing surfaces 46a-46d define a second interior perimeter 52 bounded by the second inwardly facing surfaces. The first perimeter 50 is greater than the second perimeter 52. The frame members 14, 12, 16 and 18 are dimensioned such that the second perimeter 52 is appropriately sized to receive a window assembly therein such that the frame of the window can be secured to the second inwardly facing surfaces 46a-46d.

With reference back to FIG. 2, once the wall 28 is completely constructed, a window assembly 54 is inserted into the second perimeter 52 with a forward face of the window flush with the interface edge 48a as shown. A seal 56, such as caulking or the like may be applied at the interior interface between the window assembly 54 and the second inwardly facing surface 46a to waterproof the interconnect between the window assembly and window buck. In this arrangement, the first inwardly facing surfaces 46a, 46b, 46c of frame members 12, 14 and 18 form an integral sill pan thereby further increasing the waterproofing of the window installation and reducing tendency for water ingress into the surrounding wall.

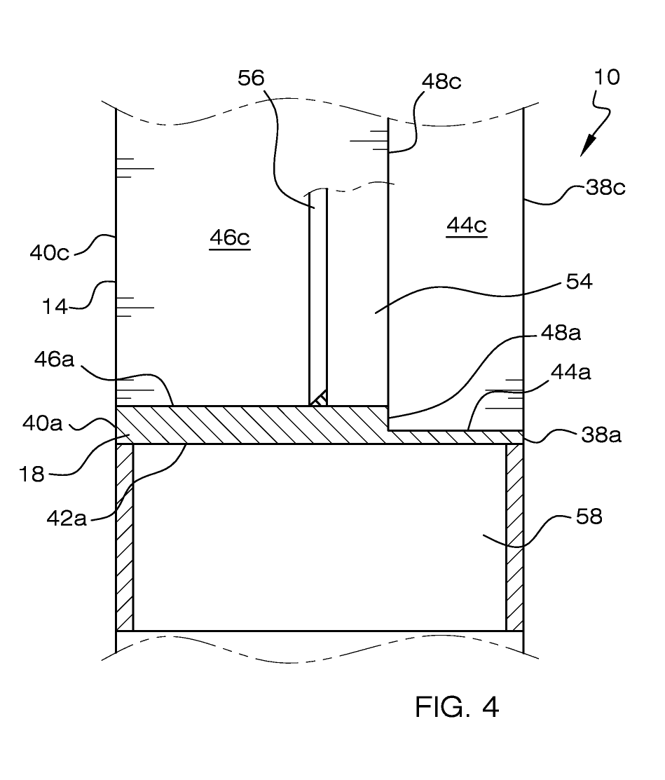

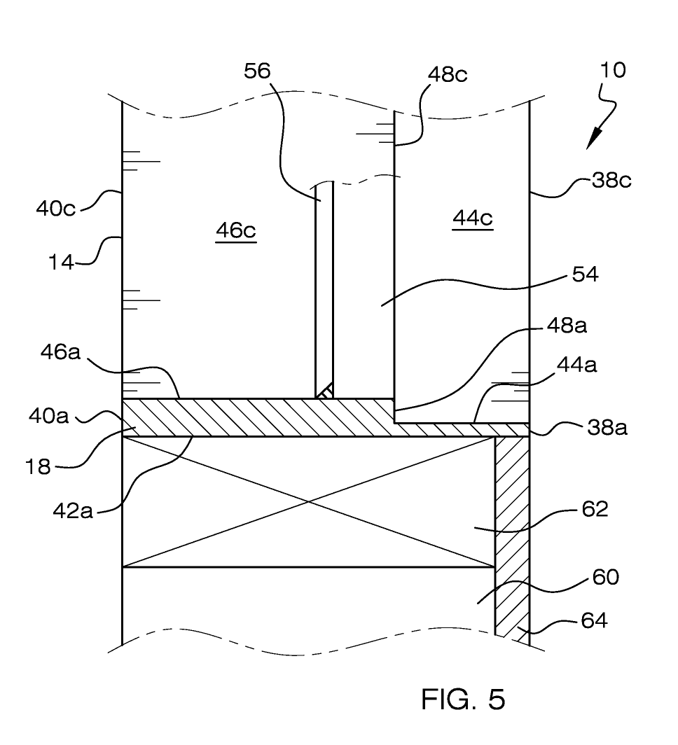

As mentioned herein above, the particular structure of the window buck 10 of the present invention permits the window buck to not only be used in cement poured walls but with block constructed walls and frame constructed walls alike. Unlike prior window bucks that include flanges positioned to be set within the concrete as it is poured such that when the concrete hardens the window buck is permanently attached to the wall via the flanges, the window buck 10 described herein is free from such flanges. By eliminating the flanges and providing frame members 12-18 with outwardly facing surfaces 42a-42d that are planar, the surfaces are capable of sitting flush against surrounding rigid surfaces, such as that of blocks or wall framing members. To illustrate this, in FIG. 4, there is shown the window buck 10 of the present invention positioned in a wall 58 of a block construction. As previously, each frame member 12-18 has a width that is at least equal to the width of the wall 58. In FIG. 5, there is shown the window buck 10 of the present invention positioned in a wall 60 of a framed construction. As previously, each frame member 12-18 has a width that is at least equal to the width of the wall 60 to include at least the wall frame 62 and exterior sheeting 64.

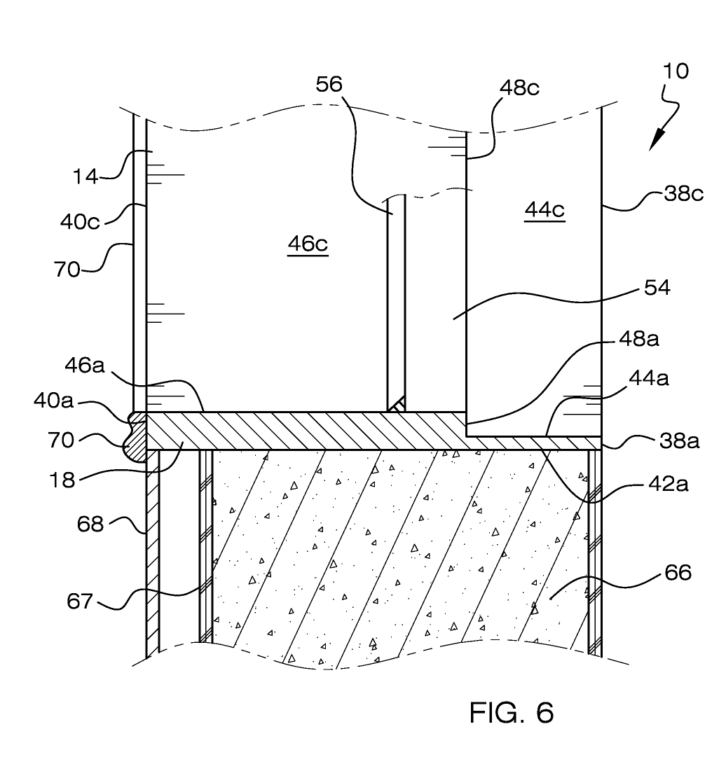

Now with reference to FIG. 6, the frame members 12-18 may be dimensioned to have a width that is greater than the wall 66 into which it is positioned such that the edges 40 extend beyond the interior facing surface 67 of the wall into the interior space of the building. The edges 40a-40d may extend a distance that is equal to the finished interior wall surface 68. In this manner, window casing 70 may be attached to the surface 68 and overlap edges 40a-40d to provide a finished window box without the use of jamb extensions.

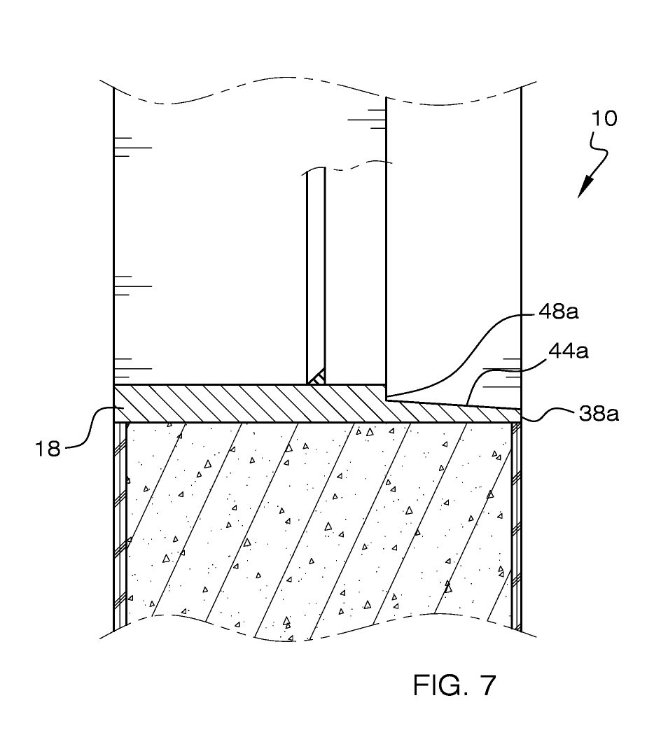

In FIG. 7, there is shown an alternative window buck 10 where the first inwardly facing surface 44a of the bottom frame member 18 is downwardly sloped in a direction from the interface edge 48a toward edge 38a to provide a sloped sill encouraging water to run off the sill to prevent water from accumulating at the junction of the interface edge and the inwardly facing surface.

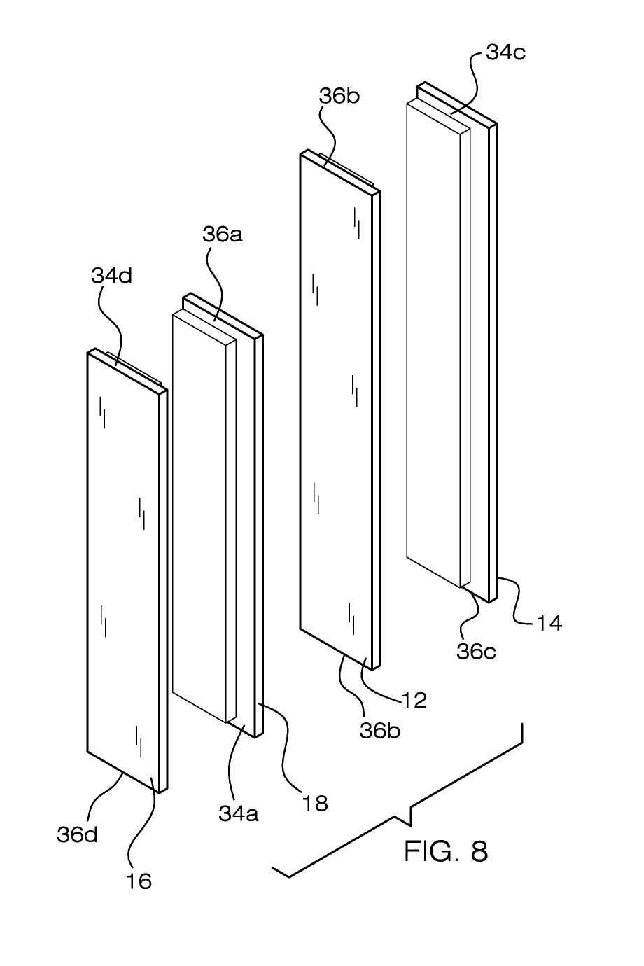

In FIG. 8 frame members 12-18 are shown before assembly into the frame 20. The ends 34a-34d and 36a-36d of each frame member 12-18 are formed to have an overlapping joint when the ends are joined together to form the frame 20. An adhesive, fusing agent or solvent appropriate for the material in which the frame members 12-18 are formed of may be used to join the ends 34a-34d and 36a-36d together during construction of the frame 20. The ends 34a-34d and 36a-36d may be fused together to provide a permanent and completely sealed joint. This is an improvement over the prior window bucks where the ends are joined together by coupling members which only serve to prevent separation of the jointed ends. In these prior window bucks an additional sealant, such as caulking must be applied at the jointed ends in an attempt to waterproof the joint.

Additionally, in prior window buck systems the frame members are delivered unassembled and in lengths that may require trimming to the desired length before being assembled on site. This may be undesirable due to the time required to size and assemble the window buck on site and the assembly on site may result in a window buck that is not perfectly square. The window buck 10 of the present invention is assembled off site to the specific requirements and is then delivered to the site ready to be positioned within the wall construction, thereby reducing installation time on site, and ensuring the window buck is perfectly square.

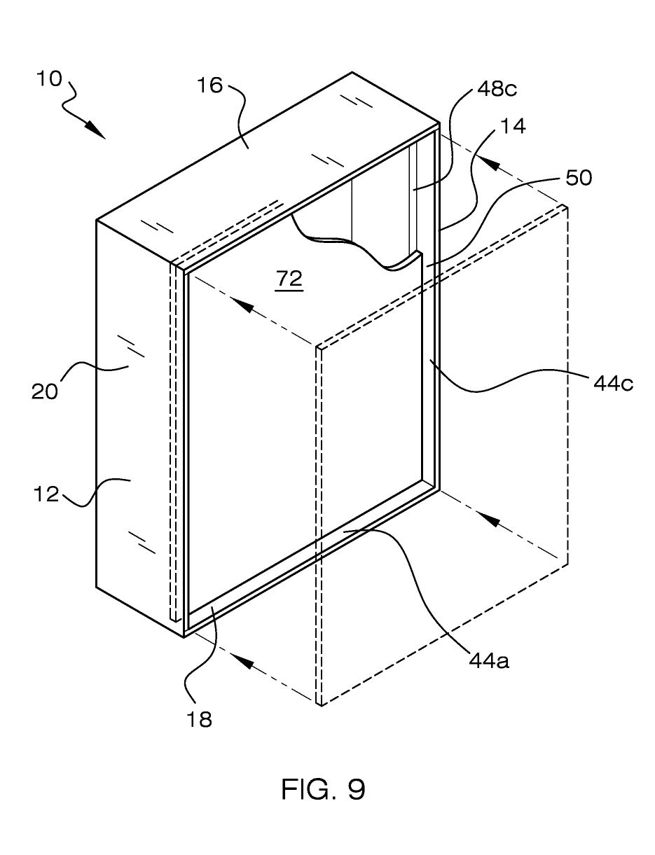

In FIG. 9, once the frame members 12-18 are assembly into the frame 20, a structural web 72 may be removably positioned within the opening 22 of the frame and detachably secured to frame members to provide structural support during transport of the window buck 10 and to support the frame members 12-18 against compressive forces during construction of the wall into which it is positioned. Once the construction of the wall has been completed, the structural web 72 is removed. Preferably, the structural web 72 is positioned within the first perimeter 50 and is sized to have a height and length equal to the first perimeter such that the peripheral edge of the web abuts the first inwardly facing surfaces 44a-44d of the frame members 12-18.

A number of embodiments of the present invention have been described. Nevertheless, it will be understood that various modifications may be made without departing from the spirit and scope of the invention. For example, while the description made herein is directed towards creating window openings in walls, the window buck of the present invention could easily be used to form other openings in walls, such as door openings. Accordingly, other embodiments are within the scope of the following claims.

What is claimed is:

1. A window buck for forming a window opening in a wall, comprising:
a plurality of elongated frame members each having a inward facing edge, an outward facing edge, opposed ends, an outward facing surface extending between said opposed ends and said inward and outward facing edges, a first inward facing surface extending along said outward facing edge, a second inward facing surface extending along said inward facing edge and at a laterally spaced distance from said first inward facing surface, an interface edge joining said first and said second inward facing surfaces, and a width that is at least equal to the thickness of the wall into which the window buck is to be placed;
said plurality of elongated frame members joined at their opposed ends to form a frame defining an opening with said first inward facing surfaces facing each other defining a first interior perimeter, and with said second inward facing surfaces facing each other defining a second interior perimeter, said first perimeter being greater than said second interior perimeter; and
wherein said outward facing surface of each of said plurality of elongated frame members is substantially planar and is free from outwardly extending flanges.

2. The window buck of claim 1, further comprising:
a reinforcing web removably positioned within said first perimeter and being sized to completely extend between said first inward facing surfaces.

3. The window buck of claim 1, wherein each of said plurality of elongated frame members are of a material of the group consisting of synthetic material, composite material and cellular contain material.

4. The window buck of claim 1, wherein said opposed ends of each of said plurality of elongated frame members are jointed together to form said frame.

5. The window buck of claim 1, wherein said plurality of elongated frame members are permanently fused at their opposed ends to form said frame.

6. The window buck of claim 1, wherein one of said plurality of elongated frame members defines a sill of said frame and said first inward facing surface thereof is sloped downward in a direction from said interface edge towards said outward facing edge.

7. The window buck of claim 1, wherein the width of each of said plurality of elongated frame members is greater than the thickness of the wall into which the window buck is to be placed; and the window buck is positioned such that said inward facing edge extends inwardly beyond the interior facing surface of the wall.

8. The window buck of claim 1, wherein each of said plurality of elongated frame members are milled.

9. A window system for a wall, comprising:
a window buck including:
a plurality of elongated frame members each having a inward facing edge, an outward facing edge, opposed ends, an outward facing surface extending between said opposed ends and said inward and outward facing edges, a first inward facing surface extending along said outward facing edge, a second inward facing surface extending along said inward facing edge and at a laterally spaced distance from said first inward facing surface, an interface edge joining said first and said second inward facing surfaces, and a width that is at least equal to the thickness of the wall into which the window buck is to be placed;
said plurality of elongated frame members joined at their opposed ends to form a frame defining an opening with said first inward facing surfaces facing each other defining a first interior perimeter, and with said second inward facing surfaces facing each other defining a second interior perimeter, said first perimeter being greater than said second interior perimeter; and
wherein said outward facing surface of each of said plurality of elongated frame members is substantially planar and is free from outwardly extending flanges;
a window assembly including a window frame;
said window buck positioned within a wall with said outward facing edge at least being flush with an outward facing surface of the wall;
wherein said window assembly is positioned within said second perimeter with said window frame secured at least to one of said second inward facing surfaces of said plurality of elongated frame members; and
a seal at the interface of said window frame and said inward facing surfaces of said plurality of elongated frame members.

10. The window system of claim 9, wherein one of said plurality of elongated frame members defines a sill of said frame and said first inward facing surface thereof is sloped downward in a direction from said interface edge towards said outward facing edge.

11. The window system of claim 9, wherein the width of each of said plurality of elongated frame members is greater than the thickness of the wall into which the window buck is to be placed; and the window buck is positioned such that said inward facing edge extends inwardly beyond the interior facing surface of the wall.
